(19) United States
(12) Patent Application Publication
(10) Pub. No.: US 2022/0132362 A1
(43) Pub. Date: Apr. 28, 2022

(54) WIRELESS COMMUNICATION METHODS FOR ADAPTIVE ENTITY AND RLC ENTITY, AND COMMUNICATION DEVICE

(71) Applicants: SHARP KABUSHIKI KAISHA, Sakai City, Osaka (JP); FG Innovation Company Limited, Tuen Mun (HK)

(72) Inventors: FANGYING XIAO, Shanghai (CN); RENMAO LIU, Shanghai (CN)

(21) Appl. No.: 17/425,551

(22) PCT Filed: Jan. 20, 2020
(86) PCT No.: PCT/CN2020/073175

§ 371 Date: Jul. 23, 2021

(30) Foreign Application Priority Data
Jan. 25, 2019 (CN) 201910077143.5

(51) Int. Cl. H04W 28/02; H04W 28/04; H04L 1/16

(52) U.S. Cl. CPC H04W 28/0273; H04W 88/14; H04L 1/1685; H04W 28/04

(57) ABSTRACT

A wireless communication method for downlink transmission by an adaptive entity in an IAB node that is a RAN node that supports wireless access and wireless backhaul access traffic of a UE is provided. The wireless communication method includes receiving an adaptive PDU or SDU including a poll; and providing an indication of the poll in a poll indication to a lower layer.

### FIELD

The present disclosure generally relates to wireless communication technology, and more specifically, the present disclosure relates to wireless communication methods for an adaptive entity and a radio link control (RLC) entity and the communication device thereof.

### BACKGROUND

In September 2018, at the RAN#81 plenary meeting of the 3rd Generation Partnership Project (3rd Generation Partnership Project: 3GPP), Qualcomm proposed a work item (please refer to Non-Patent Literature: RP-182882: New WID: Integrated Access and Backhaul for NR) relating to the NR integrated access and backhaul (Integrated Access and Backhaul for NR, IAB for short), and the work item was approved. In the RAN2#104 meeting, Hop-by-Hop Automatic Repeat request (denoted as HbH ARQ) for data transmission is used in the multi-hop IAB network. One of the problems based on the HbH ARQ is that it cannot ensure an end-to-end packet lossless delivery. In the current RLC ARQ, when the RLC transmission entity receives the RLC status report, the RLC service data unit (SDU) that is successfully transmitted is indicated to the packet data convergence protocol (PDCP) entity. The PDCP entity deletes the corresponding PDCP protocol data unit (PDU) and PDCP SDU after receiving the indication. In uplink transmission, if the data is successfully received by the access IAB node, the user equipment (UE) deletes the corresponding data, and then the access IAB node forwards the data to the next hop and deletes it. At this time, if an error occurs in the intermediate IAB node, the data that the UE considers to be successfully transmitted will not be received by the IAB donor. Based on this, one of the goals proposed by the IAB work item is to define a mechanism to ensure hop-by-hop ARQ packet lossless delivery. The present disclosure is dedicated to solving the problem of hop-by-hop ARQ packet loss delivery in downlink transmission. Specifically, the present disclosure includes the operations performed by the RLC entity and/or adaptive entity in the IAB node.

### SUMMARY

The present disclosure is implemented in view of the above problems, and it seeks to provide a wireless communication method and communication device for adaptive entity and RLC entity that may solve the problems of hop-by-hop ARQ transmission packet loss in downlink transmission.

According to an aspect of the present disclosure, there is provided a wireless communication method for downlink transmission by an adaptive entity in an integrated access and backhaul (IAB) node that is a radio access network (RAN) node that supports wireless access and wireless backhaul access traffic of a user equipment (UE), the wireless communication method comprising receiving an adaptive protocol data unit (PDU) or service data unit (SDU) including a poll; and providing an indication of the poll in a poll indication to a lower layer.

In the above wireless communication method for an adaptive entity, preferably, a destination address of the adaptive PDU or SDU comprises the IAB node or the UE connected to the IAB node.

In the above wireless communication method for an adaptive entity, preferably, an adaptive entity status report is constructed after receiving indication information related to a radio link control (RLC) status report from the lower layer.

In the above wireless communication method for an adaptive entity, preferably, after receiving the poll indication from the adaptive entity, a radio link control (RLC) entity, as the lower layer, including the poll in a RLC SDU or PDU is transmitted.

In the above wireless communication method for an adaptive entity, preferably, if the poll indication is indicated by the adaptive entity to the RLC entity, and the adaptive entity submits data associated with the RLC SDU obtained after an adaptive header is removed together with the poll indication to the RLC entity, then the RLC entity includes the poll in the RLC PDU corresponding to the RLC SDU for transmission.

In the above wireless communication method for an adaptive entity, preferably, after receiving the status report from a peer RLC entity, the RLC entity indicates relevant information of the RLC status report to the adaptive entity.

In the above wireless communication method for an adaptive entity, preferably, the relevant information of the RLC status report includes the RLC SDU or PDU that has been successfully received or that has not been successfully received.

According to another aspect of the present disclosure, there is provided a wireless communication method for an RLC entity in an integrated access and backhaul (IAB) node that is a radio access network (RAN) node supporting wireless access and wireless backhaul access traffic of a user equipment, the wireless communication method comprising receiving a poll indication from a higher layer; and providing an indication of the poll in a RLC service data unit (SDU) or protocol data unit (PDU) for transmission.

In the above wireless communication method for an RLC, preferably, the method further comprises: receiving an RLC status report from a peer RLC entity; and indicating relevant information of the RLC status report to a higher layer.

According to another aspect of the present disclosure, there is provided a communication device including at least one of an adaptive entity and a radio link control (RLC) entity in an integrated access and backhaul (IAB) that is a radio access network (RAN) node that supports wireless access and wireless backhaul access traffic of a user equipment, the communication device comprising: a processor; and a memory storing instructions, which when executed by the processor, execute a wireless communication method comprising receiving an adaptive protocol data unit (PDU) or service data unit (SDU) including a poll; and providing an indication of the poll in a poll indication to a lower layer.

In some implementations of the aspect of the present disclosure, a destination address of the adaptive PDU or SDU comprises the IAB node or the UE connected to the IAB node.

In some implementations of the aspect of the present disclosure, an adaptive entity status report is constructed after receiving indication information related to a radio link control (RLC) status report from the lower layer.

In some implementations of the aspect of the present disclosure, after receiving the poll indication from the adaptive entity, a radio link control (RLC) entity, as the lower layer, including the poll in a RLC SDU or PDU is transmitted.

In some implementations of the aspect of the present disclosure, if the poll indication is indicated by the adaptive entity to the RLC entity, and the adaptive entity submits data associated with the RLC SDU obtained after an adaptive header is removed together with the poll indication to the RLC entity, then the RLC entity includes the poll in the RLC PDU corresponding to the RLC SDU for transmission.

In some implementations of the aspect of the present disclosure, after receiving the status report from a peer RLC entity, the RLC entity indicates relevant information of the RLC status report to the adaptive entity.

In some implementations of the aspect of the present disclosure, the relevant information of the RLC status report includes the RLC SDU or PDU that has been successfully received or that has not been successfully received.

According to the wireless communication methods and communication device for the adaptive entity and the RLC entity of the present disclosure, the above operations are performed by the RLC entity and/or the adaptive entity in the IAB node, and thereby, ensuring hop-by-hop ARQ packet lossless delivery in downlink transmission.

### BRIEF DESCRIPTION OF THE DRAWINGS

The above and further features of the present disclosure will be more apparent with the detailed descriptions with the accompanying drawings, in which:

FIG. 1 is a flow chart of operations performed by an RLC entity in uplink transmission according to an implementation of the present disclosure.

FIG. 2 is a flow chart of operations performed by an adaptive entity in uplink transmission according to an implementation of the present disclosure.

FIG. 3 is a flow chart of operations performed by an adaptive entity in downlink transmission according to an implementation of the present disclosure.

FIG. 4 is a flow chart of operations performed by an RLC entity in downlink transmission according to an implementation of the present disclosure.

FIG. 5 is a schematic block diagram of a communication device according to an implementation of the present disclosure.

### DESCRIPTION

The present disclosure will be described in detail below with reference to the drawings and specific implementations. It should be noted that the present disclosure should not be limited to the specific implementations described below. In addition, for brevity, detailed descriptions of well-known technologies that are not directly related to the present disclosure are omitted to prevent confusion in the understanding of the present disclosure.

The following describes some of the terms used in the present disclosure. Unless otherwise specified, the terms used in the present disclosure are defined herein. The terms given in the present disclosure may adopt different naming conventions in the NR, LTE, and eLTE, but the unified terminology is used in this disclosure, and when applied to a specific system, they can be replaced with the terms used in the corresponding system.

RLC: Radio Link Control. The transmission mode of the RLC entity may be configured as one of a transparent transmission mode (TM), an unacknowledged mode (UM) and an acknowledged mode (AM).

MAC: Medium Access Control.

PDU: Protocol Data Unit.

SDU: Service Data Unit.

In the implementations of the present disclosure, the data received from or transmitted to a higher layer is referred to as an SDU, and the data transmitted to or received from a lower layer is referred to as a PDU. For example, the data received by the RLC entity from a higher layer or the data transmitted to a higher layer is referred to as an RLC SDU; the data received by the RLC entity from the MAC entity or the data transmitted to the MAC entity is referred to as RLC an PDU.

It should be noted that the adaptive layer is a higher layer of the RLC layer in the IAB node. In an intermediate IAB node, the adaptive PDU is an RLC SDU, because the adaptive entity, after receiving the RLC SDU, directly forwards the RLC SDU according to the data forwarding rules or the UE identification or the logical channel identification. In an access IAB node, for the RLC entity of the corresponding local UE, the adaptive SDU is an RLC SDU. This is because when the IAB node receives the adaptive PDU from other IAB nodes or IAB donors, the adaptive entity removes the header of the adaptive PDU and delivers the obtained adaptive SDU to a lower layer (for example, the RLC layer) according to the data forwarding rules or the UE identification or the logical channel identification.

At this time, the RLC SDU is the adaptive SDU. Furthermore, when the IAB node receives the RLC SDU from the RLC entity of the local UE, an adaptive header is added to obtain an adaptive PDU and the IAB node forwards the RLC SDU according to the data forwarding rules. From the perspective of the adaptive layer, the RLC SDU is the adaptive PDU. The IAB node that the user equipment (UE) accesses wirelessly is referred to as the access IAB node of the user equipment. The user equipment (UE) is referred to as the local UE of this IAB node. The following are definitions of acronyms used herein.

IAB node: IAB-node, which refers to the RAN node that supports wireless access to UEs and wirelessly backhauls the access traffic.

IAB donor: IAB-donor, a RAN node which provides a UE's interface to a core network and wireless backhauling functionality to IAB-nodes.

DRB: Data Radio Bearer carrying user plane data, or simply a data radio bearer.

SRB: Signaling Radio Bearer.

BSR: Buffer Status Reporting.

CU: Central Unit or denoted as gNB-CU. An RRC, Service Data Adaptation Protocol (SDAP) and PDCP protocol or an RRC and PDCP protocol of an en-gNB that has a hosting or at least a base station, and controls one or more Distributed Units (DUs) or gNB-DUs. The NB-CU terminates the F1 interface connected to the gNB-DU. A CU may be a CU-Control Plane (CU-CP) (or denoted as gNB-CU-CP) or a CU-User Plane (CU-UP) (or denoted as gNB-CU-UP). A CU-CP is a logical node that bears the control plane portion of the PDCP protocol of the RRC and gNB-CU, and is used for an en-gNB or gNB. The gNB-CU-CP terminates the E1 interface connected to the gNB-CU-UP and the F1-C interface connected to the gNB-DU. The CU-UP is a logical node used to bear the user plane portion of the PDCP protocol of the gNB-CU of the en-gNB, and the user plane portion of the PDCP protocol of the gNB-CU and the SDAP protocol of the gNB-CU. The gNB-CU-UP terminates the E1 interface connected to the gNB-CU-CP and the F1-U interface connected to the gNB-DU.

DU: Distributed Unit. A logical node that has at least an RLC, a MAC, and a physical layer. The DU may be located in an IAB node or an IAB donor. In the IAB node or IAB donor, the DU may also have an adaptive layer.

MT: Mobile-Termination. An MT is referred to as a function residing on an IAB-node that terminates the radio interface layers of the backhaul Uu interface toward the IAB-donor or other IAB-nodes.

Each IAB node connects to an uplink IAB node or an IAB donor via an MT, and establishes an RLC channel to a UE or an MT of a downlink IAB node via the DU. The IAB donor supports the UE and the MT of the downlink IAB node via the DU.

RLC-BearerConfig cell: The cell RLC-BearerConfig is used to configure an RLC entity, a corresponding logical channel in the MAC and the linking to a PDCP entity (served radio bearer).

The following describes an implementation for ensuring hop-by-hop ARQ packet lossless delivery in uplink transmission according to operations executed by different entities in an IAB node.

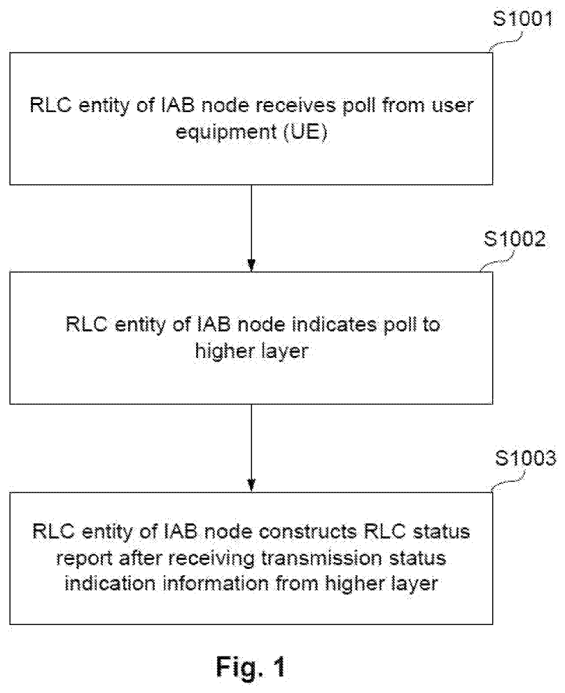

FIG. 1 is a flow chart of operations performed by an RLC entity in uplink transmission according to an implementation of the present disclosure. The following describes the operations performed by the RLC entity in uplink transmission using FIG. 1.

As shown in FIG. 1, at Step S1001, the RLC entity of the IAB node receives a poll from the user equipment (UE) or receives an RLC PDU including a poll. In other words, the poll bit P field in the received RLC PDU is set to 1.

At Step S1002, the RLC entity of the IAB node indicates the poll (referred to as the poll indication) to a higher layer (for example, the adaptive layer).

That is, RLC entity of the IAB node is optionally configured to indicate a poll to a higher layer. For example, the IAB node receives a configuration message (for example, an RRC message) from an IAB donor, and the message includes an indication identification. The indication identification may be used to indicate that the corresponding RLC entity indicates the poll to a higher layer when receiving the poll. For example, the indication identification is included in the configuration information related to the RLC bearer (for example, included in the RLC-BearerConfig element). When the identification is present or is a value of 1 or true, the corresponding poll is indicated to the higher layer. When the identification is not present or is a value of 0 or false, the corresponding poll is not indicated to the higher layer.

At Step S1003, the RLC entity of the IAB node constructs an RLC status report after receiving transmission status indication information from a higher layer. The status report is submitted to the lower layer (for example, the MAC layer) and transmitted to the UE. The transmission status indication information includes the RLC SDU or RLC PDU that has been confirmed by the destination node (for example, the destination IAB donor DU) to have been successfully received or unsuccessfully received.

It should be noted that not all the above Steps S1001, S1002, and S1003 are necessary, and the RLC entity may only perform one or more steps of the above steps. The same may be true for other implementations.

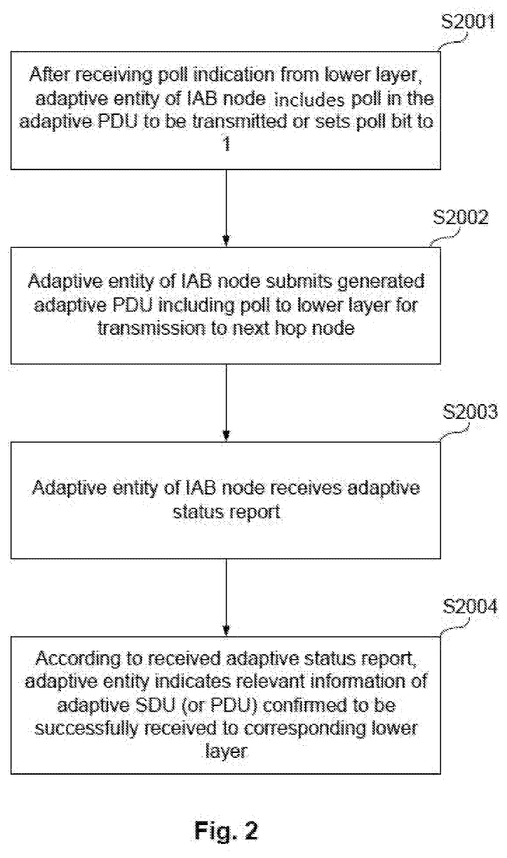

FIG. 2 is a flow chart of operations performed by an adaptive entity in uplink transmission according to an implementation of the present disclosure. The following describes the operations performed by the adaptive entity in uplink transmission using FIG. 2.

As shown in FIG. 2, at Step S2001, after receiving a poll indication from a lower layer (for example, an RLC entity), the adaptive entity of the IAB node includes the poll in the adaptive PDU to be transmitted or sets the poll bit to 1.

It should be noted that the data portion of the adaptive PDU including the poll (i.e., the adaptive SDU) is from the corresponding lower layer (for example, the RLC entity), that is, the lower layer that transmits the poll indication (for example, the RLC entity).

In one implementation, the header of the adaptive PDU may include one or more of the following fields (or referred to as domains): a P field, and a sequence number. Wherein, the P field is a poll bit field used to indicate whether the transmitting part of the adaptive entity or the adaptive entity transmitter requests its peer entity or peer adaptive entity or peer receiving part of the entity or peer receiving part of the adaptive entity to transmit the adaptive status report. The value of the P field is 0 means that the adaptive status report is not requested; the value of the P field is 1 means that the adaptive status report is requested. The sequence number field is used to indicate the sequence number of the corresponding adaptive SDU or adaptive PDU. For each adaptive SDU or adaptive PDU from a specific RLC entity, the sequence number is increased by 1.

At Step S2002, optionally, the adaptive entity of the IAB node submits the generated adaptive PDU including the poll to the lower layer (or performs transmission) for transmission to the next hop node. The next hop node may be an IAB node or an IAB donor.

Optionally, the adaptive entity starts the timer AdaptationPollRetransTimer. The value of the timer is configured by the IAB donor, for example, configured via an RRC message. If the timer expires, an adaptive SDU or adaptive PDU is selected for transmission and a poll is included therein.

At Step S2003, the adaptive entity of the IAB node receives the adaptive status report.

In one implementation, the adaptive status report may include one or more of the following: a Data (D)/Control (C) field, a Control PDU Type (CPT) field, a destination address field, a UE identification field, a bearer identification field, an ACK_SN field, an E1 field, an E2 field, a NACK_SN field, and a NACK_range field. The D/C field indicates whether the adaptive PDU is an adaptive control PDU or an adaptive data PDU, for example, 0 indicates adaptive data PDU, and 1 indicates adaptive control PDU. The CPT (Control PDU Type) field is used to indicate the type of control PDU, which can be identified by 1, 2, 3, or 4 bits. For example, a CPT value of 000 indicates a status PDU (in the implementations of the present disclosure, it is also referred to as an adaptive status PDU to distinguish it from an RLC status PDU). The destination address field is the identification of the IAB node DU (or the destination IAB donor DU) that receives the adaptive status PDU at last or the identification of the final IAB node DU (or the destination IAB donor DU) to which the adaptive status PDU is transmitted. The UE identification field and bearer identification field are used to indicate the UE and bearer that the adaptive status PDU specifies. The ACK_SN field is used to indicate the sequence number of the next adaptive SDU or PDU that is not received, and the adaptive SDU or PDU is not reported as a not-received adaptive SDU or PDU in the status report. When the transmitting part of the adaptive entity receives the adaptive status report, it considers that except for the adaptive SDU (or PDU) whose sequence number is a NACK_SN and/or the adaptive SDU (or PDU) whose sequence number is determined by a NACK_SN and NACK_range, all adaptation SDUs (or PDUs) with sequence numbers smaller than ACK_SN have been received by the peer entities or peer adaptive entities.

The NACK_SN field is used to indicate that the sequence number of the adaptive SDU (or PDU) not received by the reception adaptation entity has not been received or is lost. The E1 field is an extended bit field used to indicate whether there is a subsequent set of NACK_SN, E1 and/or E2. The E1 field value of 0 indicates that there is no subsequent set of NACK_SN, E1 and/or E2, and the E1 field value of 1 indicates that there is a subsequent set of NACK_SN, E1 and/or E2. The E2 field is used to indicate whether the consecutive adaptive SDU (or PDU) information that has not been received is included. The E2 value of 0 indicates that the NACK_range field is not included after the corresponding NACK_SN, and the E2 value of 1 indicates that the NACK_range field is included after the corresponding NACK_SN. The NACK_range field is used to indicate the number of adaptive SDUs (or PDUs) that are lost continuously starting from the first NACK_SN.

Optionally, the adaptive entity stops the timer AdaptationPollRetransTimer after receiving the adaptive status report.

At Step S2004, according to the received adaptive status report, the adaptive entity indicates the relevant information of the adaptive SDU (or PDU) that has been confirmed to be successfully received to the corresponding lower layer (referred to as the transmission status indication). The transmission status indication may be used for the lower layer (for example, the RLC entity) to construct the RLC status report. The lower layer may be the lower layer corresponding to the bearer identification included in the adaptive status report.

The following describes an implementation for ensuring hop-by-hop ARQ packet lossless delivery in downlink transmission according to operations performed by different entities in the IAB node.

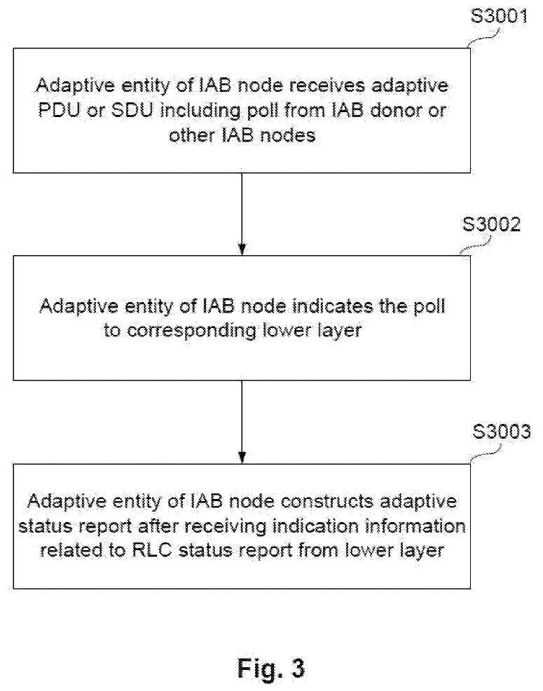

FIG. 3 is a flow chart of operations performed by an adaptive entity in downlink transmission according to an implementation of the present disclosure. The following describes the operations performed by the adaptive entity in downlink transmission using FIG. 3.

As shown in FIG. 3, at Step S3001, the adaptive entity of the IAB node receives an adaptive PDU or SDU including a poll from the IAB donor or other IAB nodes. The destination address of the adaptive PDU or SDU is the address of the IAB node or the address of the UE connected to this IAB node.

At Step S3002, the adaptive entity of the IAB node indicates the poll (also referred to as the poll indication) to the corresponding lower layer (for example, the RLC entity). In other words, the IAB node transmits an indication or transmits a poll indication to the corresponding lower layer, and the indication is used by the lower layer to include the poll in the transmitted RLC SDU (or PDU). The lower layer may be determined by the UE identification and/or bearer identification carried in the adaptive PDU.

At Step S3003, the adaptive entity of the IAB node constructs an adaptive status report after receiving the indication information related to the RLC status report from the lower layer (for example, the RLC entity).

In one implementation, the adaptive status report may include one or more of the following: a D/C field, a CPT field, a destination address field, a UE identification field, a bearer identification field, an ACK_SN field, an E1 field, an E2 field, a NACK_SN field, and a NACK_range field. The D/C field indicates whether the adaptive PDU is an adaptive control PDU or an adaptive data PDU, for example, 0 indicates adaptive data PDU, and 1 indicates adaptive control PDU. The CPT (Control PDU Type) field is used to indicate the type of control PDU, which can be identified by 1, 2, 3, or 4 bits. For example, a CPT value of 000 indicates a status PDU (in the implementations of the present disclosure, it is also referred to as an adaptive status PDU to distinguish the adaptive status PDU from an RLC status PDU). The destination address field indicates the address of the PDU that receives the adaptive status, for example, the identification of the IAB node DU.

The UE identification field and bearer identification field are used to indicate the UE and bearer that the adaptive status PDU specifies. The ACK_SN field is used to indicate the sequence number of the next adaptive SDU (or PDU) that is not received, and the adaptive SDU (or PDU) is not reported as a not-received adaptive SDU or PDU in the status report. When the transmitting part of the adaptive entity receives the adaptive status report, it considers that except for the adaptive SDU (or PDU) whose sequence number is a NACK_SN and/or the adaptive SDU (or PDU) whose sequence number is determined by a NACK_SN and NACK_range, all adaptation SDUs (or PDUs) with sequence numbers smaller than ACK_SN have been received by the peer entities or peer adaptive entities. The NACK_SN field is used to indicate the sequence number of the adaptive SDU (or PDU) that has not been received by the reception adaptation entity has not received or is lost. The E1 field is an extended bit field used to indicate whether there is a subsequent set of NACK_SN, E1 and/or E2. The E1 field value of 0 indicates that there is no subsequent set of NACK_SN, E1 and/or E2, and the E1 field value of 1 indicates that there is a subsequent set of NACK_SN, E1 and/or E2. The E2 field is used to indicate whether the consecutive adaptive SDU (or PDU) information that has not been received is included. The E2 value of 0 indicates that the NACK_range field is not included after the corresponding NACK_SN, and the E2 value of 1 indicates that the NACK_range field is included after the corresponding NACK_SN. The NACK_range field is used to indicate the number of adaptive SDUs (or PDUs) that are lost continuously starting from the first NACK_SN.

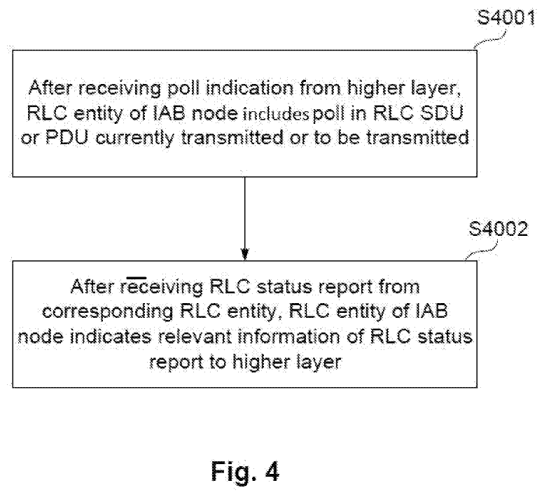

FIG. 4 is a flow chart of operations performed by an RLC entity in downlink transmission according to an implementation of the present disclosure. The following describes the operations performed by the RLC entity in downlink transmission using FIG. 4.

As shown in FIG. 4, at Step S4001, after receiving the poll indication from the higher layer, the RLC entity of the IAB node includes the poll in the RLC SDU or PDU currently transmitted or to be transmitted. If in the poll indication indicated by the adaptive entity of the IAB node to the lower layer (for example, the RLC entity), the adaptive entity submits the data obtained after the adaptive header is removed (i.e., RLC SDU) together with the poll indication to the RLC entity, then The RLC entity may transmit the poll in the RLC PDU corresponding to the RLC SDU.

At Step S4002, after receiving the RLC status report from the peer RLC entity, the RLC entity of the IAB node indicates the relevant information of the RLC status report to the higher layer (for example, the adaptive entity). The relevant information of the RLC status report includes the RLC SDU or PDU that has been successfully received and/or the RLC SDU or PDU that has not been successfully received.

In the implementations of the present disclosure, the RLC entity that receives the poll indication from the higher layer refers to the transmitting terminal of the RLC entity; the RLC entity that receives the transmission status indication from the higher layer is the receiving terminal of the RLC entity; the RLC entity that transmits the poll indication to the higher layer is the receiving terminal of the RLC entity.

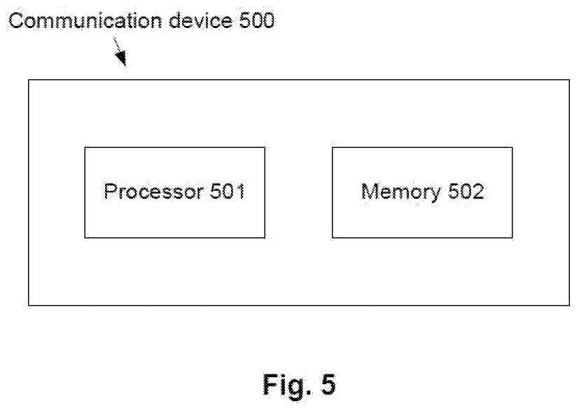

FIG. 5 is a schematic block diagram of a communication device according to an implementation of the present disclosure.

As shown in FIG. 5, the communication device 500 includes at least a processor 501 and a memory 502. The processor 501 may include, for example, a microprocessor, a microcontroller, an embedded processor, and the like. The memory 502 may include, for example, volatile memory (such as random access memory RAM), hard disk drive (HDD), non-volatile memory (such as flash memory), or other memory systems. The memory 502 stores program instructions therein. When the instructions are executed by the processor 501, it can perform the wireless communication method for the adaptive entity and/or the RLC entity as described in FIGS. 1 to 4 of the present disclosure.

In the implementations of the present disclosure, the RLC layer, the adaptive layer, and the MAC layer may be replaced with an RLC entity, an adaptation entity, and a MAC entity, respectively, and vice versa.

In the implementations of the present disclosure, the local UE of the IAB node refers to the UE directly connected to the IAB node or the node DU via a Uu or a wireless interface. In other words, the local UE means that the UE uses this IAB node as the access IAB node, then the UE is referred to as the local UE of this IAB node.

In the implementations of the present disclosure, the identification of the IAB donor may refer to the identification of the DU or CU of the IAB donor, for example, the Internet Protocol (IP) address of the DU or CU of the IAB donor. The identification of the IAB node may refer to the identification of the DU or MT of the IAB node, for example, the IP address of the DU or MT of the IAB node.

In the implementations of the present disclosure, including the poll means that the poll field or the poll bit is set to 1.

In the implementations of the present disclosure, the adaptive entity adds an adaptive layer header to the data (for example, RLC SDU) received from the UE or the local UE, and submits the generated adaptive PDU to the corresponding data forwarding rules or the destination address to the adaptive entity or lower layer. The data (adaptive PDU) received from other IAB nodes or their adaptive entities is submitted to the corresponding lower layer (for example, the corresponding adaptive entity) according to the data forwarding rules or the destination address. The data forwarding rules may be configured by the IAB donor for the IAB node, for example, configured via an RRC message.

In the implementations of the present disclosure, the data of the adaptive layer may be referred to as the adaptive SDU (which does not include the header of the adaptive layer) and the adaptive PDU (which includes the header of the adaptive layer), respectively, where the adaptive PDU may also be the adaptive data PDU or the adaptive control PDU. A field (denoted as D/C field) may be used in the header of the adaptive PDU to indicate whether the adaptive PDU is a control PDU or a data PDU. If the value of the D/C field is 0, it indicates the adaptive data PDU, and if the value of the D/C field is 1, it indicates the adaptive control PDU, and vice versa.

Based on the data forwarding rules configured in the IAB node (that is, through which port or entity the data from a certain port or entity should be transmitted), the mapping relationship between the reception logical channel and the transmission logical channel in this disclosure may be replaced by the mapping relationship between the reception RLC entity (or the receiving terminal of the RLC) and the transmission RLC entity (or the transmitting terminal of the RLC entity), or may also be replaced by the mapping relationship between the reception adaptive entity (or the receiving terminal of the adaptive entity) and the transmitting part of the adaptive entity (or the transmitting terminal of the adaptive entity), or may also be replaced by the configuration of forwarding data or the data forwarding rules.

In the implementations of the present disclosure, the lower layer of the adaptive entity may be the RLC layer or the MAC layer. If there is a one-to-one mapping relationship between the DU and/or MT and the adaptive entity (that is, one adaptive entity is defined in one DU or MT), when performing data transmission, the reception adaptive entity (or the IP layer or the entity that implements the routing function) selects the corresponding transmitting part of the adaptive entity (or MT adaptive entity) according to the destination address or the address of the IAB-donor DU (for example, the IP address of the IAB-donor DU). If there is a many-to-one mapping relationship between the DU and/or MT and the adaptive layer (that is, one adaptive entity is defined in multiple DUs and/or MTs or one adaptive entity is defined in one IAB node or donor), when performing data transmission, the adaptive entity (or the IP layer or the entity that implements the routing function) selects the corresponding RLC entity according to the destination address or the address of the IAB-donor DU (for example, the IP address of the IAB-donor DU). The implementations of the present disclosure are described based on the many-to-one mapping relationship between the DU and/or MT and the adaptive layer. If the DU and/or MT and the adaptive entity have a one-to-one mapping relationship, then the reception adaptive entity (or the IP layer or the entity that implements the routing function) needs to select the transmitting part of the adaptive entity according to the corresponding relationship between the DU and/or MT and the adaptive entity when forwarding the data.

The above transmitting part of the adaptive entity may also be used to receive data, and the reception adaptive entity may also transmit data. In this case, both the transmitting part of the adaptive entity and the reception adaptive entity can be referred to as adaptive entities; or the transmitting part of the adaptive entity is referred to as the transmitting terminal of the adaptation entity, the reception adaptive entity is referred to as the receiving terminal of the adaptive entity. Furthermore, in the implementations of the present disclosure, the routing function is integrated into the adaptive entity. If the routing function belongs to the higher layer entity of the adaptive entity, the reception adaptive entity transmits the data to the higher layer after receiving the data that needs to be forwarded, and the higher layer routes (or submits) the data to the corresponding transmitting part of the adaptive entity following the destination address. In the implementations of the present disclosure, the destination address in the adaptive PDU may not be included in the adaptive PDU, for example, as the header of the IP message included in the destination IP address. In this disclosure, unless otherwise specified, for the uplink, the destination address may refer to the address of IAB-donor (or IAB-donor DU), for example, the IP address of IAB-donor (or IAB-donor DU); for the downlink, the destination address may refer to the address of the IAB-nod (or IAB-node MT), for example, the IP address of the IAB-nod (or IAB-node MT); for the downlink, the destination address may also be the identification of the UE, for example, C-RNTI.

In the implementations of the present disclosure, for uplink, the IAB node used to receive data may be the DU of the IAB node, and the IAB donor used to receive data may be the DU of the IAB donor. For the downlink, the IAB node used to receive data may be the MT of the IAB node.

According to the present disclosure, executing programs stored on equipment may be implemented by controlling a Central Processor Unit (CPU) and causing a computer to realize the program functions of the present disclosure. The program or the information being processed by the program may be stored in volatile memory (e.g., random access memory (RAM)), a hard disk drive (HDD), non-volatile memory (e.g., flash memory), or any other suitable memory system.

The program that realizes functions of each implementation in the present disclosure may be stored on a computer-readable medium. Computer systems through reading the programs stored in the storage medium executes the programs to realize the corresponding functions. The “computer system” disclosed herein may be a computer system embedded in equipment, may include an operating system or hardware (e.g., peripheral equipment). A “computer-readable medium” may be a semiconductor storage medium, optical storage medium, a magnetic storage medium, a storage medium for short-term dynamic storing of programs, or any other storage medium readable by a computer.

Various characteristics or function modules used in the equipment disclosed in the implementations herein may be realized or implemented by electronics such as a monolithic or multiple-chip integrated circuit. The electronics designed for implementing the functions disclosed herein may include general processors, a digital signal processor (DSP), Applications Specific Integrated Circuitry (ASIC), Field Programmable Gate Arrays (FPGAs) or any other programmable logic devices, discrete gate or transistor logic, discrete hardware assembly, or any combination of the disclosed devices. A general processor may be a microprocessor, or any present processor, controller, microcontroller, or state machine. The disclosed electronics may be digital electronics or analog electronics. As semiconductor technology continues to improve, it is noted that there may be new integrated circuit technology replacing present integrated circuits, one or more implementations of the present disclosure may be implemented with the new integrated circuit technology.

Moreover, the present disclosure is not limited to the disclosed implementations. Although various examples are disclosed in each implementation, it should be noted that the present disclosure is not limited thereto. Fixed or non-mobile electronic equipment installed indoor or outdoor may be in a form of terminal equipment or communications equipment. For example, the electronic equipment may be Audio-Video equipment, kitchen equipment, cleaning equipment, air-conditioner, office equipment, vending machines, and other home appliances etc.

As above, the implementations of the present disclosure are disclosed in detail with reference to the accompanying drawings. However, the implementations are not limited to the disclosed implementations. The present disclosure also includes design variations without departing from the scope or spirit of the disclosed concepts. Furthermore, the present disclosure also encompasses modifications within the scope of the claims, implementations suitably combining various disclosed implementations. Additionally, the disclosed implementations may have component substitutions that have similar effect.

1. A wireless communication method for downlink transmission by an adaptive entity in an integrated access and backhaul (IAB) node that is a radio access network (RAN) node that supports wireless access and wireless backhaul access traffic of a user equipment (UE), the wireless communication method comprising:
receiving an adaptive protocol data unit (PDU) or service data unit (SDU) including a poll; and
providing an indication of the poll in a poll indication to a lower layer.

2. The wireless communication method for the adaptive entity according to claim 1, wherein a destination address of the adaptive PDU or SDU comprises the IAB node or the UE connected to the IAB node.

3. The wireless communication method for the adaptive entity according to claim 1, further comprising constructing an adaptive entity status report after receiving indication information related to a radio link control (RLC) status report from the lower layer.

4. The wireless communication method for the adaptive entity according to claim 1, wherein, after receiving the poll indication from the adaptive entity, a radio link control (RLC) entity, as the lower layer, including the poll in a RLC SDU or PDU is transmitted.

5. The wireless communication method for the adaptive entity according to claim 4, wherein, if the poll indication is indicated by the adaptive entity to the RLC entity, and the adaptive entity submits data associated with the RLC SDU obtained after an adaptive header is removed together with the poll indication to the RLC entity, then the RLC entity includes the poll in the RLC PDU corresponding to the RLC SDU for transmission.

6. The wireless communication method for the adaptive entity according to claim 3, wherein, after receiving the status report from a peer RLC entity, the RLC entity indicates relevant information of the RLC status report to the adaptive entity.

7. The wireless communication method for the adaptive entity according to claim 6, wherein the relevant information of the RLC status report includes the RLC SDU or PDU that has been successfully received or that has not been successfully received.

8. A wireless communication method for a radio link control (RLC) entity in an integrated access and backhaul (IAB) node that is a radio access network (RAN) node supporting wireless access and wireless backhaul access traffic of a user equipment, the wireless communication method comprising:
receiving a poll indication from a higher layer; and
providing an indication of the poll in a RLC service data unit (SDU) or protocol data unit (PDU) for transmission.

9. The wireless communication method for the RLC entity according to claim 8, further comprising:
receiving an RLC status report from a peer RLC entity; and
indicating relevant information of the RLC status report to a higher layer.

10. A communication device including at least one of an adaptive entity and a radio link control (RLC) entity in an integrated access and backhaul (IAB) that is a radio access network (RAN) node that supports wireless access and wireless backhaul access traffic of a user equipment, the communication device comprising:
a processor; and
a memory storing instructions, which when executed by the processor, execute a wireless communication method comprising:
receiving an adaptive protocol data unit (PDU) or service data unit (SDU) including a poll; and
providing an indication of the poll in a poll indication to a lower layer.

11. The communication device claim 10, wherein a destination address of the adaptive PDU or SDU comprises the IAB node or the UE connected to the IAB node.

12. The communication device claim 10, wherein an adaptive entity status report is constructed after receiving indication information related to a radio link control (RLC) status report from the lower layer.

13. The communication device claim 10, wherein after receiving the poll indication from the adaptive entity, a radio link control (RLC) entity, as the lower layer, including the poll in a RLC SDU or PDU is transmitted.

14. The communication device claim 13, wherein, if the poll indication is indicated by the adaptive entity to the RLC entity, and the adaptive entity submits data associated with the RLC SDU obtained after an adaptive header is removed together with the poll indication to the RLC entity, then the RLC entity includes the poll in the RLC PDU corresponding to the RLC SDU for transmission.

15. The communication device claim 12, wherein, after receiving the status report from a peer RLC entity, the RLC entity indicates relevant information of the RLC status report to the adaptive entity.

16. The communication device claim 15, wherein the relevant information of the RLC status report includes the RLC SDU or PDU that has been successfully received or that has not been successfully received.
